(19) United States
(12) Patent Application Publication
(10) Pub. No.: US 2025/0316763 A1
(43) Pub. Date: Oct. 9, 2025

(54) ELECTROLYTES FOR REACTIVE ANODE BATTERIES

(71) Applicant: Toyota Motor Engineering & Manufacturing North America, Inc., Plano, TX (US)

(72) Inventors: Rana Mohtadi, Northville, MI (US); Oscar Tutusaus, Ann Arbor, MI (US); Chan Shu, Ann Arbor, MI (US); Ryan Walser-Kuntz, Stamford, CT (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/628,030

(22) Filed: Apr. 5, 2024

(51) Int. Cl. H01M 10/0568; H01M 4/66; H01M 10/0569

(52) U.S. Cl. CPC H01M 10/0568; H01M 4/661; H01M 10/0569; H01M 2300/0034; H01M 2300/0042

(57) ABSTRACT

An electrolyte includes a metal cation selected from Li⁺, Na⁺, Mg²⁺, Ca²⁺, and/or Zn²⁺, a boron cluster anion, and a solvent mixture that includes an aromatic compound and at least one solvent. The aromatic compound can include benzene, toluene, o-xylene, m-xylene, p-xylene, mesitylene, hexamethylbenzene, biphenyl, naphthalene, and a compounds with partial or full substitutions of hydrogen with fluorine for these aromatic compounds. And the at least one solvent can include an ether solvent, an ester solvent, a sulfone solvent, a carbonate solvent, poly(ethylene oxide), an ionic liquid, a nitrile solvent, and/or combinations thereof.

### TECHNICAL FIELD

The present disclosure generally relates to electrolytes, and particularly to electrolytes for batteries with reactive anodes.

### BACKGROUND

Liquid electrolytes with lithium bis(fluorosulfonyl)imide (LiFSI) salts in ether and/or esters solvents have been reported to perform well in batteries with lithium metal anodes. However, such electrolytes have also been reported to exhibit higher than desired resistance to ionic mobility and metal plating and metal stripping of the anode.

The present disclosure addresses these issues with liquid electrolytes, and other issues related to electrolytes.

### SUMMARY

In one form of the present disclosure, an electrolyte includes a metal cation selected from Li⁺, Na⁺, Mg²⁺, Ca²⁺, or Zn²⁺, a boron cluster anion, and a solvent mixture that includes an aromatic compound and at least one solvent. In some variations, the aromatic compound is an aromatic aprotic solvent and the at least one solvent is at least one additional solvent. And in such variations, the aromatic aprotic solvent can be benzene, benzene with partial or full substitutions of hydrogen with fluorine, toluene, toluene with partial or full substitutions of hydrogen with fluorine, o-xylene, o-xylene with partial or full substitutions of hydrogen with fluorine, m-xylene, m-xylene with partial or full substitutions of hydrogen with fluorine, p-xylene, p-xylene with partial or full substitutions of hydrogen with fluorine, and mesitylene, mesitylene with partial or full substitutions of hydrogen with fluorine, and combinations thereof.

In another form of the present disclosure, an electrolyte includes a metal cation selected from Li⁺, Na⁺, Mg²⁺, Ca²⁺, or Zn²⁺, a mixture of boron cluster anions, and a solvent mixture with at least one solvent and an aromatic compound selected from benzene, benzene with partial or full substitutions of hydrogen with fluorine, toluene, toluene with partial or full substitutions of hydrogen with fluorine, o-xylene, o-xylene with partial or full substitutions of hydrogen with fluorine, m-xylene, m-xylene with partial or full substitutions of hydrogen with fluorine, p-xylene, p-xylene with partial or full substitutions of hydrogen with fluorine, and mesitylene, mesitylene with partial or full substitutions of hydrogen with fluorine, hexamethylbenzene, hexamethylbenzene with partial or full substitutions of hydrogen with fluorine, biphenyl, biphenyl with partial or full substitutions of hydrogen with fluorine, naphthalene, naphthalene with partial or full substitutions of hydrogen with fluorine, and combinations thereof.

In still another form of the present disclosure, an electrochemical cell includes an anode selected from an intercalation anode, a metal anode, or an alloy anode, an anode current collector that includes a reactive metal selected from Mg, Ca, and/or Si, a cathode selected from an insertion cathode, a conversion cathode, or an organic cathode, and an electrolyte. The electrolyte includes at least one metal cation selected from Li⁺, Na⁺, Mg²⁺, Ca²⁺, and/or Zn²⁺, a boron cluster anion, and a solvent mixture with an aromatic compound and at least one solvent.

These and other features of the composite salt mixture and its preparation will become apparent from the following detailed description when read in conjunction with the figures and examples, which are exemplary, not limiting.

### BRIEF DESCRIPTION OF THE DRAWINGS

The present teachings will become more fully understood from the detailed description and the accompanying drawings, wherein:

FIG. 1A is a plot of coulombic efficiency as a function of cycle number for Li plating and Li stripping (Li plating/stripping) of a Li anode in a Li|Cu coin cell with a 1 molar (M) LiCB₁₁H₁₂ in 1,2-dimethoxyethane (DME) electrolyte and a Li|Cu coin cell with a 1M LiFSI in DME electrolyte, both cycled at 0.125 mA·cm⁻² to 0.0625 mAh·cm⁻²;

FIG. 1B is a plot of voltage-time cycling profiles for the Li plating/stripping of the Li anode in Li|Cu coin cells shown in FIG. 1A;

FIG. 1C is an enlarged view of the 1^{st} to the 5^{th} cycling profiles in FIG. 1B;

FIG. 1D is an enlarged view of the 36^{th} to the 40^{th} cycling profiles in FIG. 1B;

FIG. 1E is a Nyquist impedance plot of imaginary impedance as a function of real impedance for 1M LiCB₁₁H₁₂ in DME and 1M LiFSI in DME during the Li plating/stripping of the Li anode in Li|Cu coin cells, and with the inset being an enlarged illustrating bulk resistance (intersection with the horizontal axis) for the 1M LiCB₁₁H₁₂-DME electrolyte and the 1M LiFSI-DME electrolyte;

FIG. 2A is a plot of coulombic efficiency as a function of cycle number for Li plating/stripping of a Li anode in a Li|Cu coin cell with a 1M LiCB₁₁H₁₂ in a 1:1 vol dibutyl ether (DBE)/toluene electrolyte and a Li|Cu coin cell with a 1M LiFSI in 1:1 vol DBE/toluene electrolyte, both cycled at 0.125 mA·cm⁻² to 0.0625 mAh·cm⁻²:

FIG. 2B is a plot of the 1^{st} to 5^{th} voltage-time cycling profiles for the Li plating/stripping of the Li anode in Li|Cu coin cells referenced in FIG. 2A;

FIG. 2C is a plot of the 97^{th} to 99^{th} voltage-time cycling profiles for the Li plating/stripping of the Li anode in Li|Cu coin cells referenced in FIG. 2A;

FIG. 2D is a Nyquist impedance plot of imaginary impedance as a function of real impedance for 1M LiCB₁₁H₁₂ in 1:1 vol DBE/toluene and 1M LiFSI in 1:1 vol DBE/toluene during the Li plating/stripping of the Li anode in the Li|Cu coin cells referenced in FIG. 2A, and with the inset being an enlarged plot illustrating bulk resistance (intersection with the horizontal axis) for the 1M LiCB₁₁H₁₂-DBE/toluene electrolyte and the 1M LiFSI-DBE/toluene electrolyte;

FIG. 3A is a plot of coulombic efficiency as a function of cycle number for Li plating/stripping of a Li anode in a Li|Cu coin cell with a 1M LiCB₁₁H₁₂ in a 1:1 vol dibutyl ether (DBE)/mesitylene electrolyte, cycled at 0.25 mA·cm⁻² to 0.5 mAh·cm⁻²;

FIG. 3B is a plot of the 1^{st} to 5^{th} voltage-time cycling profiles for the Li plating/stripping of the Li anode in the Li|Cu coin cell referenced in FIG. 3A;

FIG. 3C is a plot of the 96^{th} to 100^{th} voltage-time cycling profiles for the Li plating/stripping of the Li anode in the Li|Cu coin cell referenced in FIG. 3A;

FIG. 3D is a Nyquist impedance plot of imaginary impedance as a function of real impedance for the 1M LiCB₁₁H₁₂ in 1:1 vol DBE/mesitylene electrolyte during the Li plating/stripping of the Li anode in the Li|Cu coin cell referenced in FIG. 3A, and with the inset being an enlarged plot illustrating bulk resistance (intersection with the horizontal axis) for the 1M LiCB₁₁H₁₂-DBE/mesitylene electrolyte;

FIG. 4A is a plot of voltage-time cycling profiles for the Li plating of a Mg current collector in a Li|Mg coin cell with a 1M LiCB₁₁H₁₂ in a 1:1 vol DBE/toluene electrolyte and the Li plating of a Cu current collector in a Li|Cu coin cell with a 1M LiCB₁₁H₁₂ in a 1:1 vol DBE/toluene electrolyte, both cycled at 0.25 mA·cm⁻² to 3.5 mAh·cm⁻²;

FIG. 4B is an enlarged view of FIG. 4A between 0 mV and −10 mV;

FIG. 4C is a Nyquist impedance plot of imaginary impedance as a function of real impedance before Li plating on the Mg current collector in the Li|Mg coin cell and Li Plating on the Cu current collector in the Li|Cu coin cell referenced in FIG. 4A, and with the inset being an enlarged plot illustrating bulk resistance (intersection with the horizontal axis) for the 1M LiCB₁₁H₁₂-DBE/toluene electrolyte;

FIG. 4D is a Nyquist impedance plot of imaginary impedance as a function of real impedance after Li plating on the Mg current collector in the Li|Mg coin cell referenced in FIG. 4A at 0.25 mAh·cm⁻², 3.5 mAh·cm⁻², 10 mAh·cm⁻², and 20 mAh·cm⁻², and with the inset being an enlarged plot illustrating bulk resistance (intersection with the horizontal axis) for the 1M LiCB₁₁H₁₂-DBE/toluene electrolyte and the different plating conditions;

FIG. 5A is a plot of coulombic efficiency as a function of cycle number for Li plating/stripping of a Li anode in a Li|Cu coin cell with a 1M LiCB₁₁H₁₂ in a 1:1 vol DBE/mesitylene electrolyte, cycled at 0.125 mA·cm⁻² to 0.5 mAh·cm⁻²;

FIG. 5B is a plot of the 1^{st} to 5^{th} voltage-time cycling profiles for the Li plating/stripping of the Li anode in the Li|Cu coin cell referenced in FIG. 5A;

FIG. 5C is a plot of the 96^{th} to 100^{th} voltage-time cycling profiles for the Li plating/stripping of the Li anode in the Li|Cu coin cell referenced in FIG. 5A;

FIG. 5D is a Nyquist impedance plot of imaginary impedance as a function of real impedance for the 1M LiCB₁₁H₁₂ in 1:1 vol DBE/mesitylene electrolyte during the Li plating/stripping of the Li anode in the Li|Cu coin cell referenced in FIG. 3A, and with the inset being an enlarged plot illustrating bulk resistance (intersection with the horizontal axis) for the 1M LiCB₁₁H₁₂-DBE/mesitylene electrolyte;

FIG. 6A is a plot of coulombic efficiency as a function of cycle number for Li plating/stripping of a Li anode in a Li|Cu coin cell with a 1M LiFSI in a 1:1 vol DBE/mesitylene electrolyte, cycled at 0.125 mA·cm⁻² to 0.5 mAh·cm⁻²;

FIG. 6B is a plot of voltage-time cycling profiles for the Li plating/stripping of the Li anode in the Li|Cu coin cell referenced in FIG. 6A;

FIG. 6C is a Nyquist impedance plot of imaginary impedance as a function of real impedance for 1M LiFSI in 1:1 vol DBE/mesitylene before the Li plating/stripping of the Li anode in the Li|Cu coin cell referenced in FIG. 6A, and with the inset being an enlarged plot illustrating bulk resistance (intersection with the horizontal axis) for the 1M LiFSI in in 1:1 vol DBE/mesitylene electrolyte; and

FIG. 7 illustrates an electrochemical cell with an electrolyte according to the teachings of the present disclosure.

It should be noted that the figures set forth herein are intended to exemplify the general characteristics of the composite salt mixtures and electrolytes of the present technology, for the purpose of the description of certain aspects. The figures may not precisely reflect the characteristics of any given aspect and are not necessarily intended to define or limit specific forms or variations within the scope of this technology.

### DETAILED DESCRIPTION

The present disclosure provides liquid and/or semi-liquid electrolytes (referred to herein simply as “electrolytes”) with enhanced performance in electrochemical cells with reactive anodes and/or reactive current collectors such a lithium (Li), sodium (Na), magnesium (Mg), calcium (Ca), zinc (Zn), and silicon (Si). The electrolytes combine weakly coordinating anions based on boron clusters with solvent mixtures that include an aromatic compound, e.g., one or more aromatic aprotic solvents and/or solid aromatics, such that high coulombic efficiencies and reduced metal plating and stripping overpotentials are provided for electrochemical cells with reactive anodes and/or reactive current collectors.

As used herein, the term “aromatic” refers to an organic molecule with six (6) carbon rings joined in a planar hexagonal ring. Also, the at least one solvent (e.g., when the aromatic compound is a solid) or the at least one additional solvent (e.g., when the aromatic compound is an aromatic solvent) can be one (1) to five (5) additional solvents selected from an additional, but different aromatic solvent and/or one or more of the polar solvating solvents noted above. And the content or composition of the aromatic solvent can be between about 1 mol % and about 80 mol % of a total solvent content.

As noted above, in some variations the aromatic compound is an aromatic aprotic solvent, for example, benzene, toluene, o-xylene, m-xylene, p-xylene, mesitylene, and other related aromatic and conjugated compounds capable of forming solutions of boron cluster type salts in the absence or presence of other polar solvating solvents such ether solvents, ester solvents, sulfone solvents, carbonate solvents, poly(ethylene oxide) solvents with a molecular mass up to 20,000, ionic liquids, and nitrile solvents, among others. The aromatic compound can also include partial or full substitutions of hydrogen in aforementioned solvents with fluorine. For example, the aromatic aprotic solvent can be benzene, benzene with partial or full substitutions of hydrogen with fluorine, toluene, toluene with partial or full substitutions of hydrogen with fluorine, o-xylene, o-xylene with partial or full substitutions of hydrogen with fluorine, m-xylene, m-xylene with partial or full substitutions of hydrogen with fluorine, p-xylene, p-xylene with partial or full substitutions of hydrogen with fluorine, and mesitylene, mesitylene with partial or full substitutions of hydrogen with fluorine, and combinations thereof. Non-limiting examples of such aromatic aprotic solvents with partial or full substitutions of hydrogen with fluorine include fluorobenzene, 1,2-difluorobenzene, 1,3-difluorobenzene, 1,4-difluorobenzene, 1,3,5-trifluorobenzene, hexafluorobenzene, (trifluoromethyl)benzene, 1,2-bis(trifluoromethyl)benzene, 1,3-bis(trifluoromethyl)benzene, 1,4-bis(trifluoromethyl)benzene, 1,3,5-tris(trifluoromethyl)benzene, and hexa(trifluoromethyl)benzene.

In the alternative, or in addition, to, in some variations the aromatic compound is a solid, e.g., hexamethylbenzene, biphenyl, naphthalene, combinations thereof, and partial or full substitutions of hydrogen in such solid aromatics with fluorine. For example, the aromatic compound can be hexamethylbenzene, hexamethylbenzene with partial or full substitutions of hydrogen with fluorine, biphenyl, biphenyl with partial or full substitutions of hydrogen with fluorine, naphthalene, naphthalene with partial or full substitutions of hydrogen with fluorine, and combinations thereof. And in such variations, the electrolytes according to the teachings of the present disclosure include the solid aromatic and at least one solvent.

In some variations, and when the liquid and/or semi-liquid electrolytes include a solid aromatic, the solid aromatic may or may not dissolve in the solvent mixture, an aromatic solvent when present, and/or the at least one additional solvent when present.

The boron cluster anion can be one or more of [B_{y}H_{(y-z)}R_{z}]²⁻, [CB_{(y-1)}H_{(y-z)}R_{z}]⁻, [C₂B_{(y-2)}H_{(y-t-1)}Rₜ]⁻, [C₂B_{(y-3)}H_{(y-t)}Rₜ]⁻, or [C₂B_{(y-3)}H_{(y-t-1)}Rₜ]²⁻, where y is an integer within a range of 6 to 12, z is an integer within a range of 0 to y, t is an integer within a range of 0 to (y−1), and R is a linear, branched-chain, or cyclic C1-C18 alkyl or partially or totally fluorinated alkyl group. In the alternative, or in addition to, the boron cluster anion can be a halogenated boron cluster anion selected from one or more of [B_{y}H_{(y-z-i)}R_{z}Xᵢ]²⁻, [CB_{(y-1)}H_{(y-z-i)}R_{z}Xᵢ]⁻, [C₂B_{(y-2)}H_{(y-t-j-1)}RₜXⱼ]⁻, [C₂B_{(y-3)}H_{(y-t-j)}RₜXⱼ]⁻, or [C₂B_{(y-3)}H_{(y-t-j-1)}RₜXⱼ]²⁻, and where y is an integer within a range of 6 to 12; (z+i) is an integer within a range of 0 to y, (t+j) is an integer within a range of 0 to (y−1), X is F, Cl, Br, I, or a combination thereof, and R is a linear, branched-chain, or cyclic C1-C18 alkyl or fluoroalkyl group.

The electrolytes include a cation, e.g., an alkali metal cation, an alkaline-earth cation and/or a transition metal cation. In some variations, the cation is a lithium cation (Li⁺), a sodium cation (Na⁺), a magnesium cation (Mg²⁺), a calcium cation (Ca²⁺), and/or zinc cation (Zn²⁺).

In some variations, the electrolytes can include an additive salt, for example a Li salt, a Na salt, a Ca salt, a Zn salt, a Mg salt, a cesium (Cs) salt, and combinations thereof. For example, the additive salt can be a bis(fluorosulfonyl)imide, a bis(trifluoromethanesulfonyl)imide, a borohydride, an alkoxyborate, and/or an alkoxyaluminate salt of Li, Na, Ca, Zn, Mg, and/or Cs. And in such variations the content or concentration of the additive salt can be between about 1 mol % and about 50 mol % of the boron cluster anion plus additive salt total content.

In some variations, the additive salt(s) increases the concentration of a cation of interest in a given electrolyte. In the alternative, or in addition to, the additive salt(s) smooth cation deposition onto the anode (i.e., metal plating) and/or current collector of an electrochemical cell by the additive cation of the additive salt having a lower deposition potential than the electrolyte cation. For example, a Cs additive salt can be included to smooth Li plating. And in some variations, the additive salt can be a boron cluster based salt, e.g., CsCB₁₁H₁₂.

The teachings of the present disclosure provide enhanced electrolytes compared to traditional electrolytes with respect to metal plating/stripping as evidenced by, and as discussed below, increased ionic conductivity and lower overpotentials for metal plating. Not being bound by theory, the lower overpotentials for metal plating can be due to the low propensity of cations to bind with the delocalized electron charges in the aromatic solvent-anion mixtures. In addition, the electrolytes according to the teachings of the present disclosure exhibit high compatibility with reactive metal anodes as evidenced by metal plating/stripping coulombic efficiencies exceeding 99%.

In addition to high compatibility with reactive metal anodes, and as discussed in greater detail below, the electrolytes according to the teachings of the present disclosure also exhibit high compatibility with reactive metal current collectors, e.g., Mg and Ca current collectors, which are prone to oxide and passivation layer formation when exposed to traditional electrolytes.

It should be understood that electrolytes with the LiFSI salt are known as the best performing electrolytes with respect Li metal anodes. For example, very high Li metal plating and stripping efficiencies exceeding 99% can be achieved in electrolyte solutions containing concentrations of LiFSI beyond 1 M in ether solvents as reported in the reference “High rate and stable cycling of lithium metal anode”, Qian et al. Nat Commun 6, 6362, 2015). Alternatively, incorporating cosolvents like bis(2,2,2-trifluoroethyl) ethers or solutions of LiFSI in esters or ethers, in what is known as locally highly concentrated electrolytes, can result in very high Li metal plating and stripping efficiencies as disclosed in the reference “High-Voltage Lithium-Metal Batteries Enabled by Localized High-Concentration Electrolytes”, Zhang et al., Adv. Mater. 2018, 30 (21), 1706102). Additionally, LiFSI can be present in ethereal-toluene mixtures at concentrations of about 1 M as disclosed in the reference “Data-Driven Electrolyte Design for Lithium Metal Anodes”, Cui et al., Proceedings of the National Academy of Sciences, 120, 10 (2023). And in all these electrolyte solutions, the FSI⁻ anion is considered the key for the enablement of these electrolytes through the formation of an inorganic content rich, LiF-based layer on the Li metal that supports efficient and relatively stable cycling as concluded in the reference “Localized High Concentration Electrolytes for High Voltage Lithium-Metal Batteries: Correlation between the Electrolyte Composition and Its Reductive/Oxidative Stability”, Balbuena et al., Chem. Mater. 2020, 32, 5973-5984.

However, and as discussed below, the combination of the boron cluster anions and the solvent mixtures with an aromatic compound according to the teachings of the present disclosure outperform the above reported electrolytes containing LiFSI.

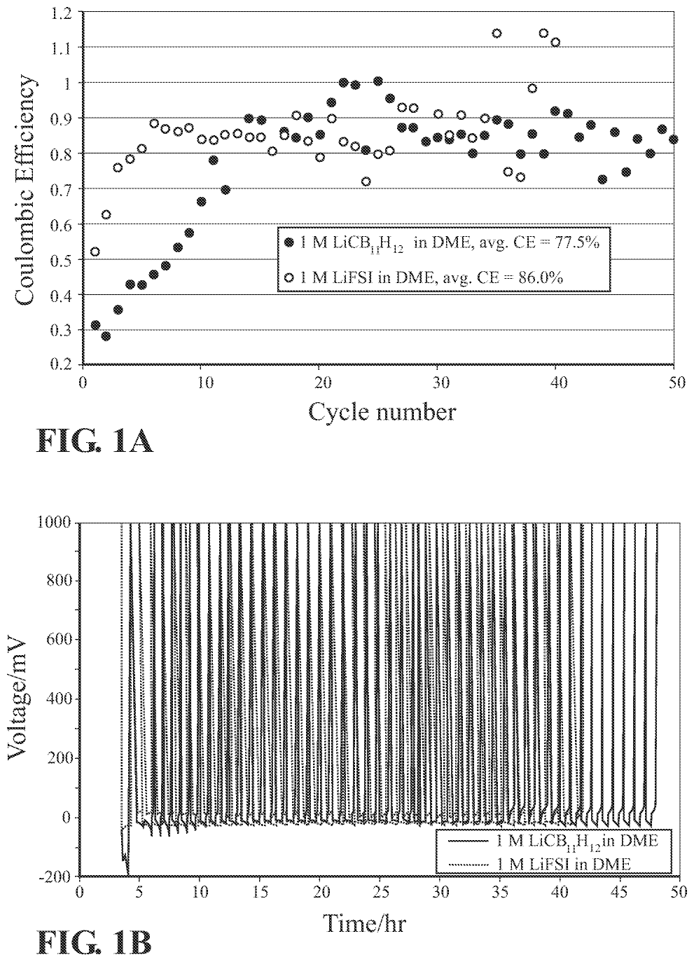

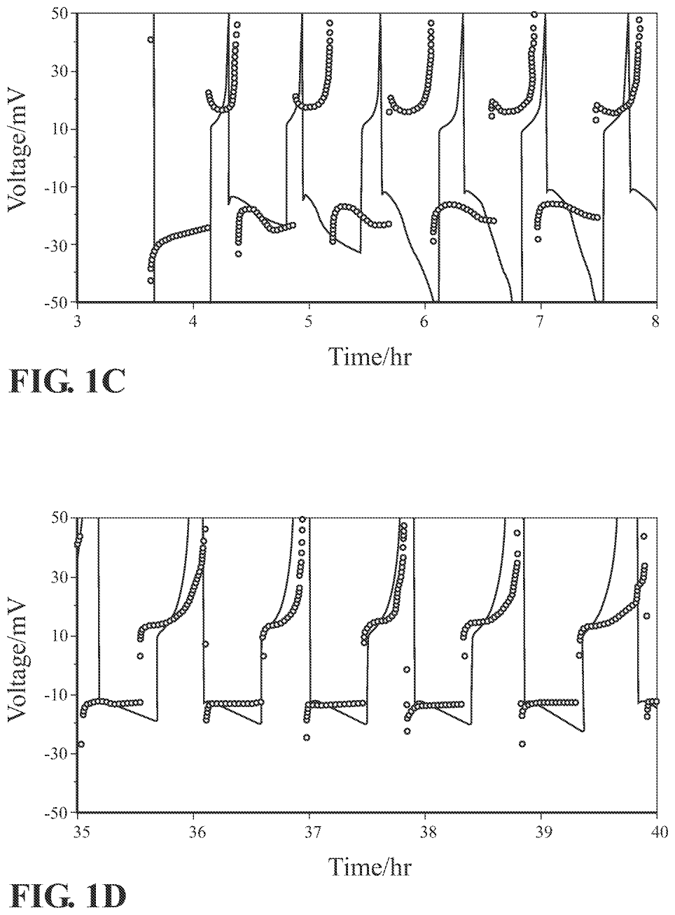

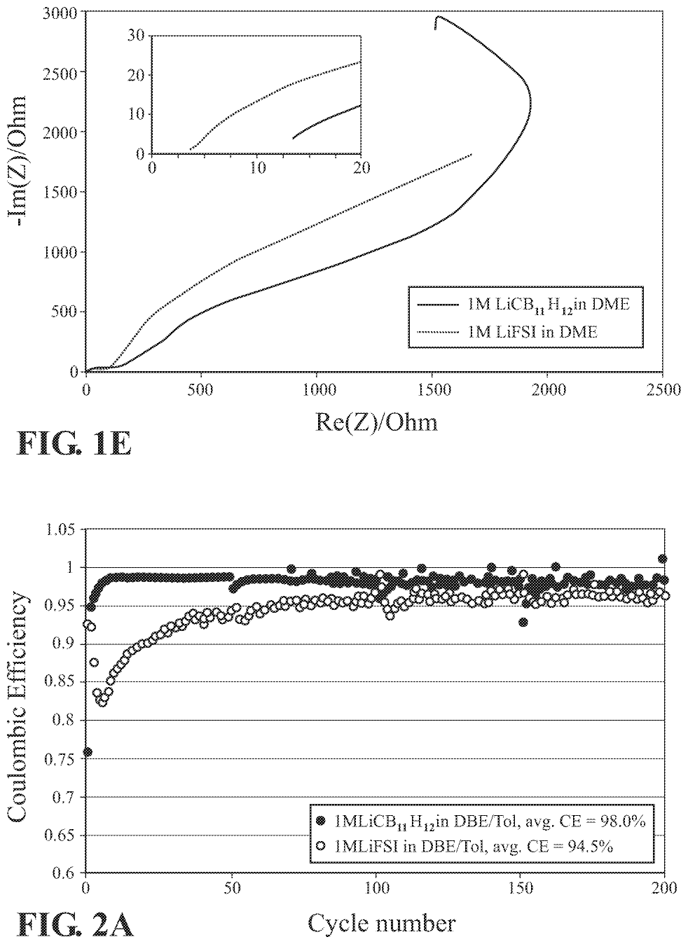

Referring to FIGS. 1A-IE, results from Li plating/stripping of the Li anodes in two Li anode-Cu cathode coin cells (hereafter referred to herein as “Li|Cu coin cells”) are shown. One of the Li|Cu coin cells had an electrolyte of 1M LiCB₁₁H₁₂ in a typical 1,2-dimethoxyethane (DME) solvent (referred to herein simply as “DME”) and another of the Li|Cu cells had an electrolyte of 1M LiFSI in DME. The 1M LiCB₁₁H₁₂ in DME electrolyte was synthesized by dissolving 135 mg of LiCB₁₁H₁₂ in 900 L DME, and stirring the solution for half an hour to give a transparent 1M solution. The 1M LiFSI in DME electrolyte was synthesized by dissolving 168.5 mg of LiFSI in 900 L DME, and stirring the solution for half an hour to give a transparent 1M solution. Also, the Li|Cu coin cells were cycled at 0.125 mA·cm⁻² to 0.0625 mAh·cm⁻².

Referring specifically to FIG. 1A, the coulombic efficiencies as a function of Li plating/stripping cycle number for the two Li|Cu coin cells noted above are shown. And as observed, neither Li|Cu coin cell, i.e., neither electrolyte, performed exceptionally well with the 1M LiCB₁₁H₁₂-DME electrolyte performance being much poorer. Particularly, the Li|Cu coin cell with the 1M LiCB₁₁H₁₂-DME electrolyte exhibited an average coulombic efficiency (CE) of 77.5% and the Li|Cu coin cell with the 1M LiFSI-DME electrolyte exhibited an average CE of 86.0%.

Referring to FIGS. 1B-IE, voltage-time cycling profiles, i.e., voltage as a function of time for the Li plating/stripping, of the two Li|Cu coin cells are shown in FIG. 1B, an isolated and enlarged view of the 1^{st} to the 5^{th} voltage-time cycling profiles is shown in FIG. 1C, an isolated and enlarged view of the 36^{th} to the 40^{th} voltage-time cycling profiles is shown in FIG. 1D, and imaginary impedance as a function of real impedance for the 1M LiCB₁₁H₁₂-DME electrolyte and the 1M LiFSI-DME electrolyte are shown in FIG. 1E. Also, the inset plot in FIG. 1E shows the bulk resistance for the 1M LiCB₁₁H₁₂-DME electrolyte and the 1M LiFSI-DME electrolyte.

As observed from FIGS. 1C-1D, relatively high and unstable plating overpotentials for the 1M LiCB₁₁H₁₂-DME electrolyte were observed and a higher impedance for the 1M LiCB₁₁H₁₂-DME electrolyte versus the 1M LiFSI-DME electrolytes was observed (FIG. 1E). This demonstrates the inferiority of the LiCB₁₁H₁₂-DME electrolyte vs. the 1M LiFSI-DME electrolyte. Accordingly, electrolytes with the LiCB₁₁H₁₂ salt in a DME solvent did not perform well.

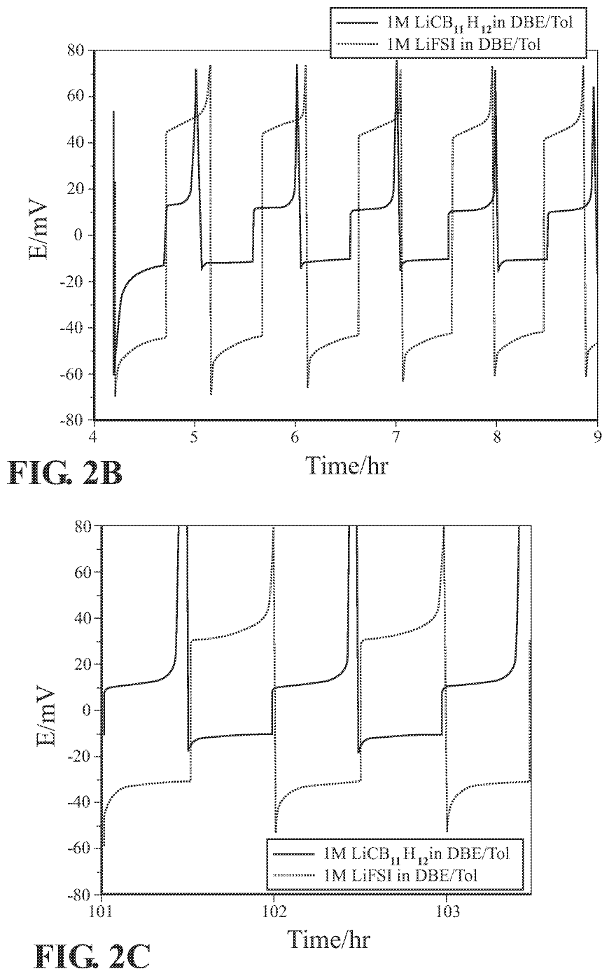

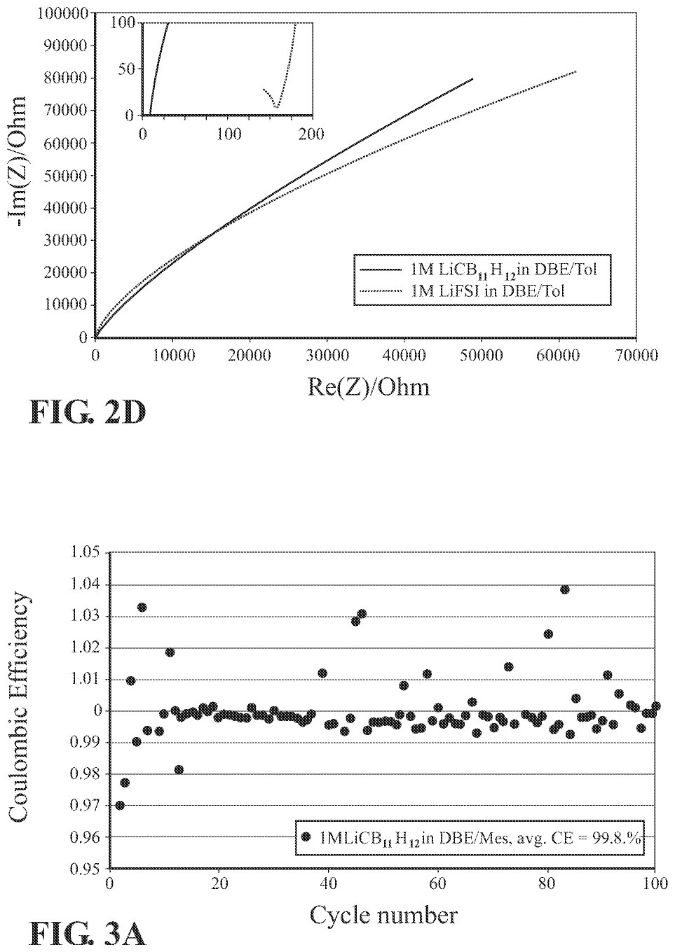

Referring now to FIGS. 2A-2D, results from Li plating/stripping in a Li|Cu coin cell with an electrolyte of 1M LiCB₁₁H₁₂ in a 1:1 vol dibutyl ether (DBE)/toluene solvent mixture and a Li|Cu coin cell with an electrolyte of 1M LiFSI in a 1:1 vol DBE/toluene solvent mixture are shown. The 1M LiCB₁₁H₁₂-1:1 vol DBE/toluene electrolyte was synthesized by dissolving 135 mg of LiCB₁₁H₁₂ in 900 L of a 1:1 vol DBE/toluene, and stirring the solution for half an hour to give a transparent 1M solution. The 1M LiFSI-1:1 vol DBE/toluene electrolyte was synthesized by dissolving 168.5 mg of LiFSI in 900 L DBE/toluene, and stirring the solution for half an hour to give a transparent 1M solution. Also, the Li|Cu coin cells were cycled at 0.125 mA·cm⁻² to 0.0625 mAh·cm⁻² for 200 cycles.

Referring specifically to FIG. 2A, the coulombic efficiencies as a function of Li plating/stripping cycle number for the two Li|Cu coin cells referenced above are shown. And as observed, the Li|Cu coin cell with the 1M LiCB₁₁H₁₂-1:1 vol DBE/toluene electrolyte exhibited an average CE of 98.0% and the Li|Cu coin cell with the 1M LiFSI-1:1 vol DBE/toluene electrolyte exhibited an average CE of only 94.5%. Accordingly, the FSI⁻ anion in the 1:1 vol DBE/toluene solvent mixture does not result in a CE improvement compared to the CB₁₁H₁₂⁻ anion. Stated differently, the combination of the CB₁₁H₁₂⁻ anion with the solvent containing the aromatic aprotic solvent toluene provides enhanced CE efficiency compared to the combination of the FSI⁻ anion with the same solvent.

Referring specifically to FIGS. 2B-2D, an isolated and enlarged view of the 1^{st} to the 5^{th} Li plating/stripping voltage-time cycling profiles is shown in FIG. 2B, an isolated and enlarged view of the 97^{th} to the 99^{th} Li plating/stripping voltage-time cycling profiles is shown in FIG. 2C, and the imaginary impedance as a function of real impedance for the 1M LiCB₁₁H₁₂-1:1 vol DBE/toluene electrolyte and the 1M LiFSI-1:1 vol DBE/toluene electrolyte prior to the cycling test is shown in FIG. 2D. Also, the inset plot in FIG. 2D shows the bulk resistance for the 1M LiCB₁₁H₁₂-1:1 vol DBE/toluene electrolyte and the 1M LiFSI-1:1 vol DBE/toluene electrolyte.

As observed from FIGS. 2B-2C, the 1M LiFSI-1:1 vol DBE/toluene electrolyte exhibited an overpotential between 30.3-42.0 mV while the 1M LiCB₁₁H₁₂-1:1 vol DBE/toluene electrolyte exhibited an overpotential of only 11.3 mV. Also, the 1M LiFSI-1:1 vol DBE/toluene electrolyte exhibited a bulk resistance of 156.94 ohms (Ω) while the 1M LiCB₁₁H₁₂-1:1 vol DBE/toluene electrolyte exhibited a significantly lower bulk resistance of only 8.5Ω (FIG. 2D). Accordingly, the 1M LiCB₁₁H₁₂-1:1 vol DBE/toluene electrolyte exhibited an overpotential that was about 3 to 4 times less than the overpotential of the 1M LiFSI-1:1 vol DBE/toluene electrolyte and a bulk resistance that was about 18 times less than the bulk resistance of the 1M LiFSI-1:1 vol DBE/toluene electrolyte. And it should be understood that simply replacing the LiFSI salt in the 1:1 vol DBE/toluene solvent mixture with the LiCB₁₁H₁₂ salt does not produce a predictable result, as shown before, the performance of LiCB₁₁H₁₂ in the typical DME solvent is far inferior to the LiFSI in the DME solvent i.e., the LiCB₁₁H₁₂ salt with the 1:1 vol DBE/toluene solvent mixture provides unexpected results.

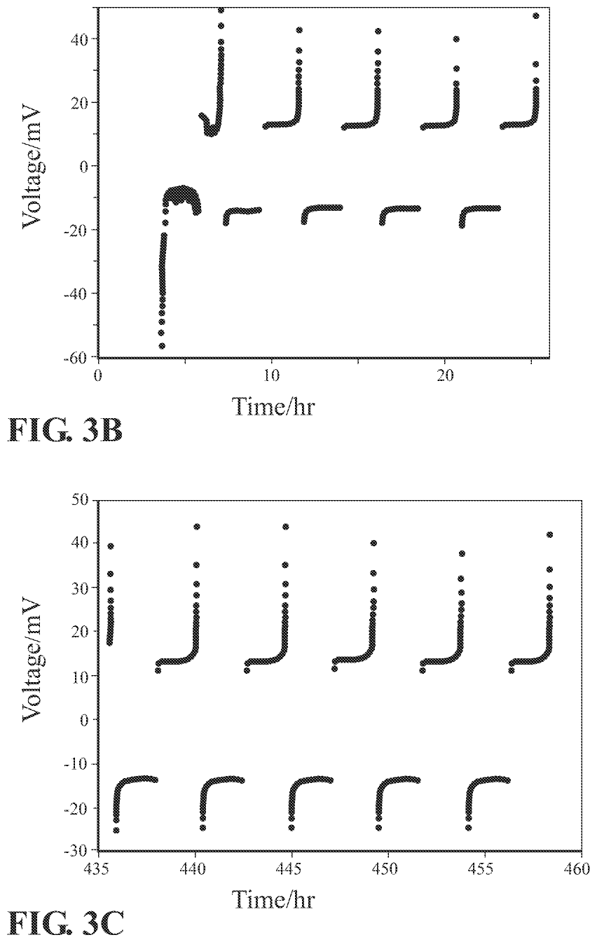

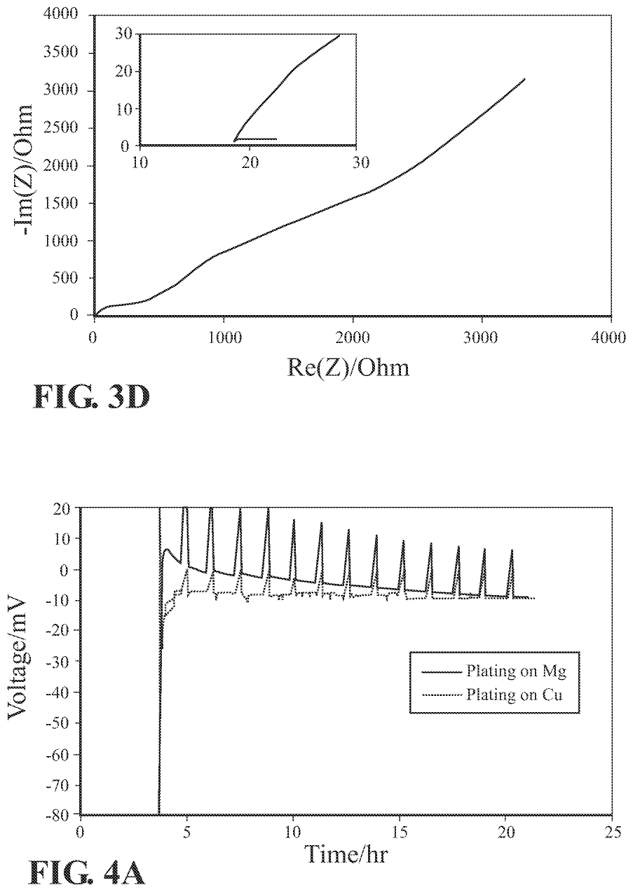

Referring to FIGS. 3A-3D, results from Li plating/stripping in a Li|Cu coin cell with an electrolyte of 1M LiCB₁₁H₁₂ in a different solvent mixture according to the teachings of the present disclosure are shown. Particularly, FIGS. 3A-3D show results for Li plating/stripping in a Li|Cu coin cell with a 1M LiCB₁₁H₁₂-1:1 vol DBE/mesitylene electrolyte are shown. The 1M LiCB₁₁H₁₂-1:1 vol DBE/mesitylene electrolyte was synthesized by dissolving 135 mg of LiCB₁₁H₁₂ in 900 L of a 1:1 vol DBE/mesitylene solvent mixture, and stirring the solution for half an hour to give a transparent 1M solution. Also, the Li|Cu coin cell was cycled at 0.25 mA·cm² to 0.5 mAh·cm⁻² for 100 cycles.

Referring specifically to FIG. 3A, the CE as a function of Li plating/stripping cycle number for the Li|Cu coin cell. And as observed, the Li|Cu coin cell with the 1M LiCB₁₁H₁₂-1:1 vol DBE/mesitylene electrolyte exhibited an average CE of 99.8%. Accordingly, the CB₁₁H₁₂⁻ anion in solvent mixture with a different aromatic aprotic solvent (i.e., toluene replaced with mesitylene) provides high CE.

Referring specifically to FIGS. 3B-3D, an isolated and enlarged view of the 1^{st} to the 5^{th} Li plating/stripping voltage-time cycling profiles is shown in FIG. 3B, an isolated and enlarged view of the 97^{th} to the 99^{th} Li plating/stripping voltage-time cycling profiles is shown in FIG. 3C, and the imaginary impedance as a function of real impedance for the 1M LiCB₁₁H₁₂-1:1 vol DBE/mesitylene electrolyte prior to the cycling test is shown in FIG. 3D. Also, the inset plot in FIG. 3D shows the bulk resistance for the 1M LiCB₁₁H₁₂-1:1 vol DBE/mesitylene electrolyte. And as observed from the figures, the 1M LiCB₁₁H₁₂-1:1 vol DBE/mesitylene electrolyte exhibited an overpotential between 13.5 to 13.8 mV and a bulk resistance of only 18.64Ω before cycling. Accordingly, the 1M LiCB₁₁H₁₂-1:1 vol DBE/mesitylene electrolyte exhibited a significantly lower Li plating/stripping overpotential and bulk resistance when compared to the 1M LiFSI-1:1 vol DBE/toluene electrolyte.

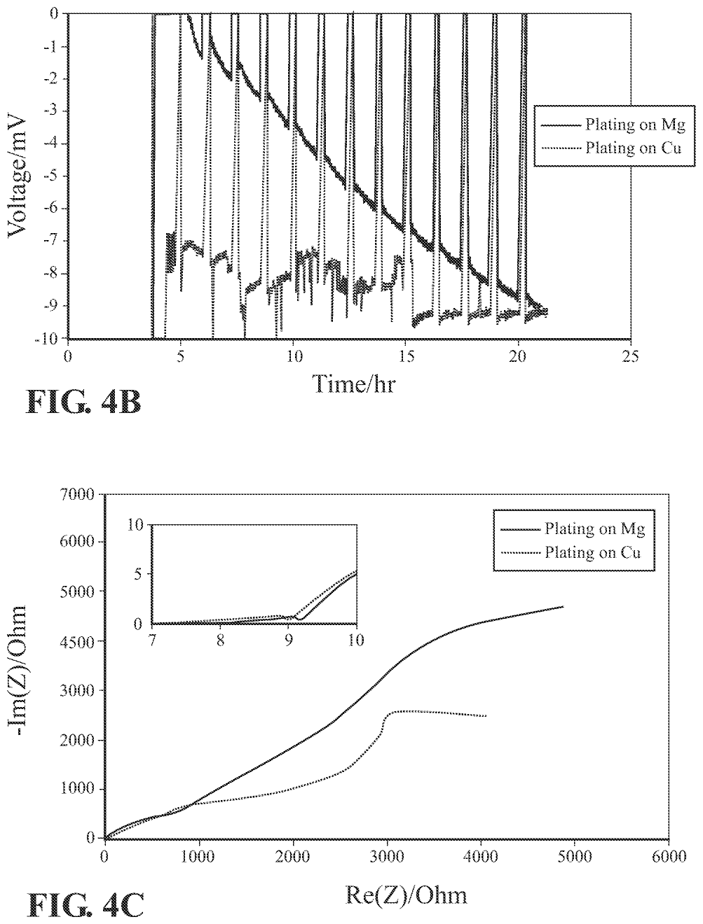

In order to study the effect of Li plating on reactive metal current collectors, and with reference to FIGS. 4A-4D, Li plating of the Mg cathode in a Li|Mg coin cell and Li plating of the Cu cathode in a Li|Cu coin cell, both with a 1M LiCB₁₁H₁₂-1:1 vol DBE/toluene electrolyte, were investigated. The 1M LiCB₁₁H₁₂-1:1 vol DBE/toluene electrolyte was synthesized by dissolving 135 mg of LiCB₁₁H₁₂ in 900 L of a 1:1 vol DBE/toluene, and stirring the solution for half an hour to give a transparent 1M solution. For the Li|Mg coin cell, a Mg foil was cleaned with a glass blade before assembly. Also, the Li|Mg and Li|Cu coin cells were run at 0.25 mA·cm⁻² and the impedance was measured after plating every 0.25 mAh·cm⁻² Li.

Referring specifically to FIGS. 4A-4B, complete plating profiles of plating Li on the Mg current collector and the Cu current collector referenced above, at 0.25 mA·cm⁻², are shown in FIG. 4A, and an enlarged view between 0 and −10 mV of the plating profiles in FIG. 4A is shown in FIG. 4B. And as observed from FIGS. 4A-4B, a Mg—Li alloy was formed on the Mg foil of the Li|Mg coin cell as evidenced by the Li plating potential being greater than 0 mV versus Li/Li⁺. And compared to the Li plating of the Cu current collector under the same conditions, Li plating of the Mg current collector was more stable and exhibited a lower overpotential for a plating capacity up to 3.5 mAh·cm⁻². This shows that the electrolytes herein allow for the effective use of reactive current collectors such as Mg. As such, the ability to use these current collectors improves the performance of the battery anode (negative electrode).

Referring specifically to FIGS. 4C-4D, the imaginary impedance as a function of real impedance for the 1M LiCB₁₁H₁₂-1:1 vol DBE/toluene electrolyte in the Li|Mg and Li|Cu coin cells is shown in FIG. 4C, with the inset plot showing the bulk resistance before Li plating (9.15Ω for the Li|Mg coin cell and 9.00Ω for the Li|Cu coin cell). And the imaginary impedance as a function of real impedance for the 1M LiCB₁₁H₁₂-1:1 vol DBE/toluene electrolyte in the Li|Mg coin cell after plating of 0.25 mAh·cm², 3.5 mAh·cm², 10 mAh·cm², and 20 mAh·cm² is shown in FIG. 4D. It should be understood from the inset plot in FIG. 4D that the bulk resistance of the 1M LiCB₁₁H₁₂ in 1:1 vol DBE/toluene in the Li|Mg coin cell does not increase significantly even after Li plating of 20 mAh·cm².

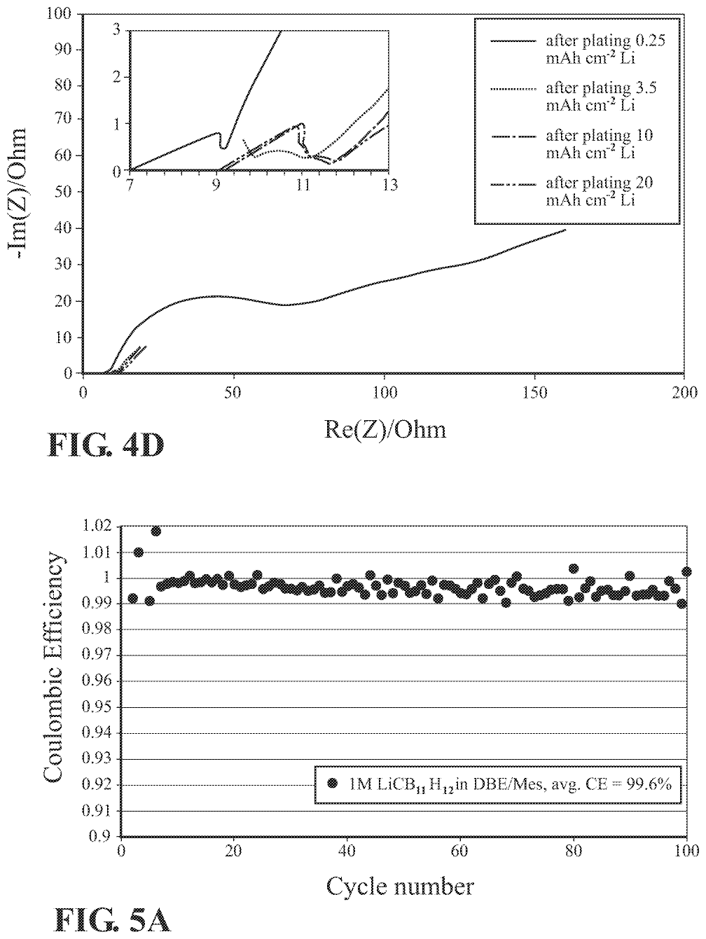

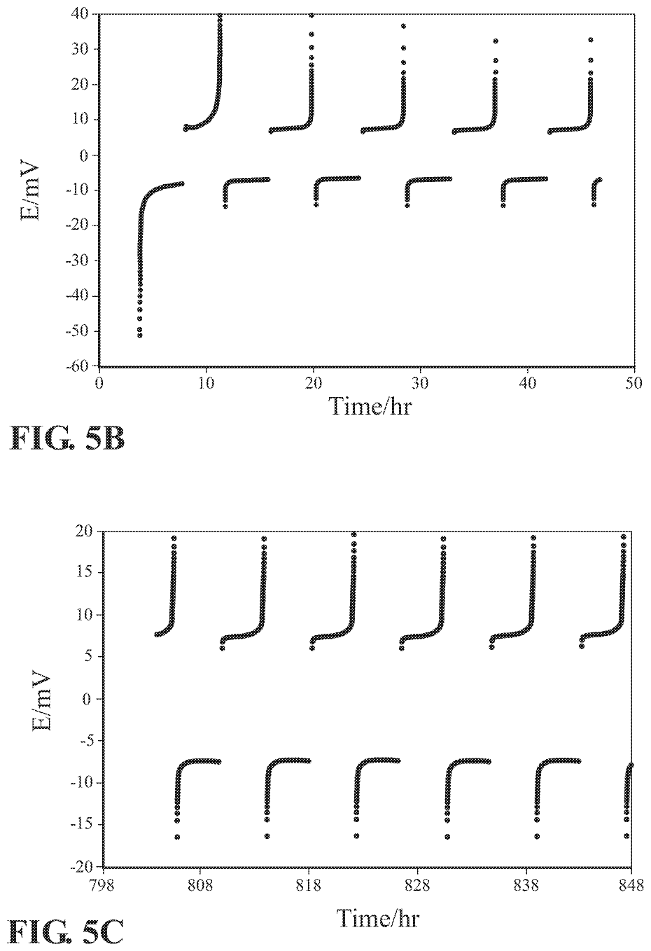

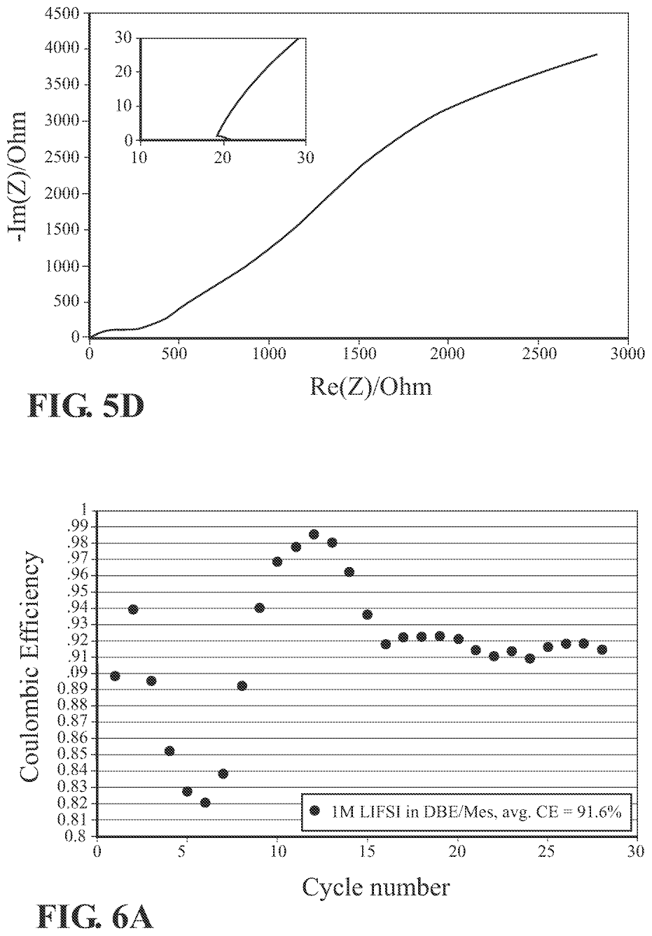

Referring to FIGS. 5A-5D, results from Li plating/stripping a Li anode in a Li|Cu coin cell with an electrolyte of 1M LiCB₁₁H₁₂ in a 1:1 vol DBE/mesitylene when cycled at 0.125 mA·cm² to 0.5 mAh·cm⁻² for 100 cycles are shown. The 1M LiCB₁₁H₁₂-1:1 vol DBE/mesitylene electrolyte was synthesized by dissolving 135 mg of LiCB₁₁H₁₂ in 900 L of a 1:1 vol DBE/mesitylene, and stirring the solution for half an hour to give a transparent 1M solution.

Referring specifically to FIG. 5A, the CE as a function of Li plating-stripping cycle number for the Li|Cu coin cell is shown. And as observed, the Li|Cu coin cell with the 1M LiCB₁₁H₁₂-1:1 vol DBE/mesitylene electrolyte exhibited an average CE of 99.6%.

Referring to FIGS. 5B-5C, an isolated and enlarged view of the 1^{st} to the 5^{th} Li plating/stripping voltage-time cycling profiles is shown in FIG. 5B, an isolated and enlarged view of the 96^{th} to the 100^{th} Li plating/stripping voltage-time cycling profiles is shown in FIG. 5C, and the imaginary impedance as a function of real impedance for the 1M LiCB₁₁H₁₂-1:1 vol DBE/mesitylene electrolyte prior to the cycling test is shown in FIG. 5D. Also, the inset plot in FIG. 5D shows the bulk resistance for the 1M LiCB₁₁H₁₂-1:1 vol DBE/mesitylene electrolyte. And as observed from the figures, the 1M LiCB_{II}H₁₂ in 1:1 vol DBE/mesitylene exhibited an overpotential between 6.0 to −7.5 mV and a bulk resistance of only 19.13Ω before cycling.

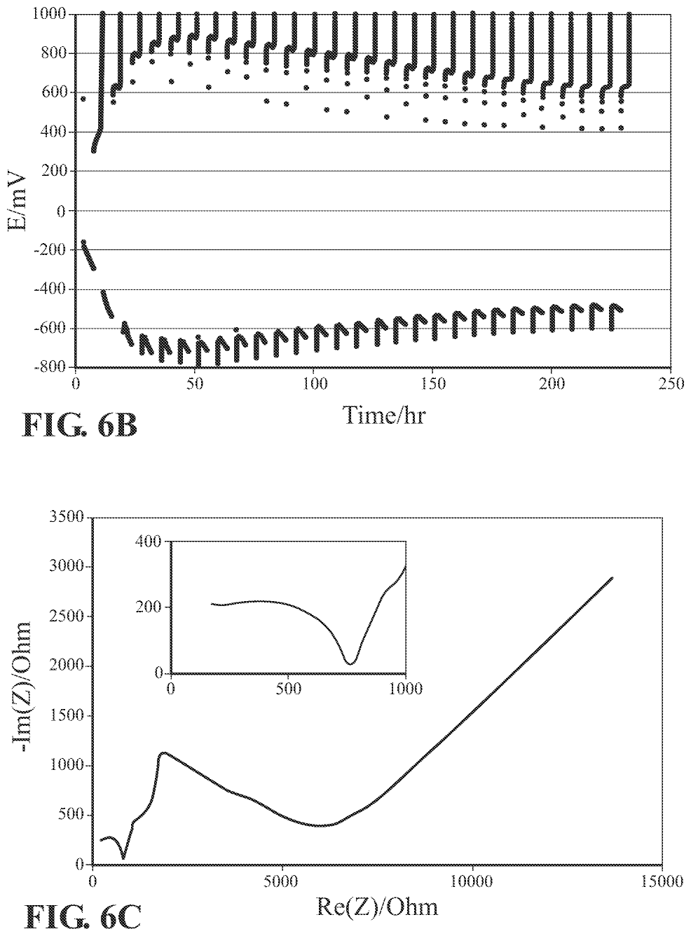

In comparison, FIGS. 6A-6D show the results of Li plating/stripping in a Li|Cu coin cell with the 1M LiFSI-1:1 vol DBE/mesitylene electrolyte cycled at 0.125 mA·cm² to 0.5 mAh·cm⁻² for 28 cycles. The 1M LiFSI-1:1 vol DBE/mesitylene electrolyte was synthesized by dissolving 168.5 mg of LiFSI in 900 L of a 1:1 vol DBE/mesitylene, and stirring the solution for half an hour to give a transparent 1M solution.

Referring specifically to FIG. 6A, the CE as a function of cycle number for the Li|Cu coin cell is shown. And as observed, the Li|Cu coin cell with the 1M LiFSI-1:1 vol DBE/mesitylene electrolyte exhibited an average CE of only 91.6%.

Referring to FIGS. 6B-6C, Li plating/stripping voltage-time cycling profiles are shown in FIG. 6B, and the imaginary impedance as a function of real impedance is shown in FIG. 6C. Also, the inset plot in FIG. 6C shows the bulk resistance (horizontal axis) as function of cycle number (vertical axis) for the 1M LiFSI-1:1 vol DBE/mesitylene electrolyte. And as observed from the figures, the 1M LiFSI-1:1 vol DBE/mesitylene electrolyte exhibited an overpotential between 600 to −600 mV and a bulk resistance of 765.34Ω before cycling. This demonstrates that the 1M LiFSI-1:1 vol DBE/mesitylene is far inferior to the 1M LiCB₁₁H₁₂-1:1 vol DBE/mesitylene and thus the outstanding performance of the 1M LiCB₁₁H₁₂-1:1 vol DBE/mesitylene is not an expected outcome, i.e., is not a result of DBE/mesitylene solvent mixture itself but rather its combination with the LiCB₁₁H₁₂ salt.

Accordingly, it should be understood that liquid or semi-liquid electrolytes with the combination of a boron cluster anion and a solvent mixture that includes an aromatic aprotic compound and at least one additional solvent significantly outperform electrolytes with a boron cluster anion and a solvent mixture that does not include an aromatic aprotic compound and/or electrolytes with a non-boron cluster anion such as the FSI⁻ anion and a solvent mixture that does include an aromatic aprotic compound.

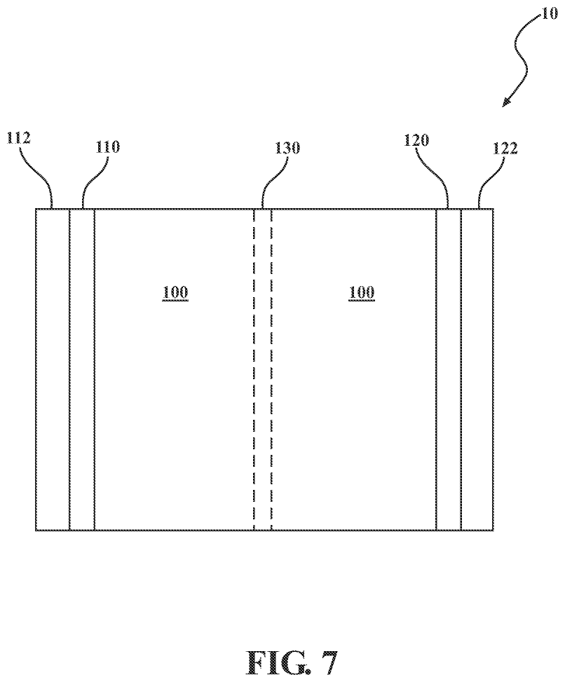

Referring now to FIG. 7, an electrochemical cell (battery) 10 according to the teachings of the present disclosure is shown. The battery 10 includes an electrolyte 100 according to the teachings of the present disclosure disposed between a reactive anode 110 and a cathode 120. In some variations, the reactive anode 110 is an intercalation anode, a metal anode, or an alloy anode. Also, in some variations the cathode 120 is an insertion cathode, a conversion cathode, or an organic cathode. An anode current collector 112 is in electrical contact with the reactive anode 110 and a cathode current collector 122 is in electrical contact with the cathode 120. In some variations, a separator 130 is disposed between the reactive anode 110 and the cathode 120.

The electrolyte 100 includes a combination of weakly coordinating anions based on boron clusters and solvent mixtures with an aromatic compound and at least one additional solvent as discussed above. In some variations, the reactive anode 110 is a Li anode, a Mg anode, a Na anode, a Ca anode, a Zn anode, or a Si anode, among others. In at least one variation, the anode current collector 112 and/or the cathode current collector 122 is formed from a reactive metal/material such as Mg, Ca, Al, or Si, among others.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple forms or variations having stated features is not intended to exclude other forms or variations having additional features, or other forms or variations incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with a form or variation is included in at least one form or variation. The appearances of the phrase “in one variation” or “in one form” (or variations thereof) are not necessarily referring to the same form or variation. It should be also understood that the various method steps discussed herein do not have to be carried out in the same order as depicted, and not each method step is required in each form or variation.

The foregoing description of the forms or variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

While particular forms or variations have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

What is claimed is:

1. An electrolyte comprising:
a metal cation selected from the group consisting of Li⁺, Na⁺, Mg²⁺, Ca²⁺, and/or Zn²⁺;
a boron cluster anion; and
a solvent mixture comprising an aromatic compound and at least one solvent.

2. The electrolyte according to claim 1, wherein the boron cluster anion is selected from the group consisting of [B_{y}H_{(y-z)}R_{z}]²⁻, [CB_{(y-1)}H_{(y-z)}R_{z}]⁻, [C₂B_{(y-2)}H_{(y-t-1)}Rₜ]⁻, [C₂B_{(y-3)}H_{(y-t)}Rₜ]⁻, or [C₂B_{(y-3)}H_{(y-t-1)}Rₜ]²⁻, where y is an integer within a range of 6 to 12, z is an integer within a range of 0 to y, t is an integer within a range of 0 to (y−1), and R is a linear, branched-chain, or cyclic C1-C18 alkyl or partially or totally fluorinated alkyl group.

3. The electrolyte according to claim 1, wherein the boron cluster anion is a halogenated boron cluster anion selected from the group consisting of [B_{y}H_{(y-z-i)}R_{z}Xᵢ]²⁻, [CB_{(y-1)}H_{(y-z-i)}R_{z}Xᵢ]⁻, [C₂B_{(y-2)}H_{(y-t-j-1)}RₜXⱼ]⁻, [C₂B_{(y-3)}H_{(y-t-j)}RₜXᵢ]⁻, or [C₂B_{(y-3)}H_{(y-t-j-1)}RₜXⱼ]²⁻, and where y is an integer within a range of 6 to 12; (z+i) is an integer within a range of 0 to y, (t+j) is an integer within a range of 0 to (y−1), X is F, Cl, Br, I, or a combination thereof, and R is a linear, branched-chain, or cyclic C1-C18 alkyl or fluoroalkyl group.

4. The electrolyte according to claim 1, wherein the aromatic compound is an aromatic aprotic solvent and the at least one solvent is at least one additional solvent.

5. The electrolyte according to claim 4, wherein the at least one additional solvent is selected from the group consisting of an ether solvent, an ester solvent, a sulfone solvent, a carbonate solvent, poly(ethylene oxide), an ionic liquid, a nitrile solvent, and combinations thereof.

6. The electrolyte according to claim 1, wherein:
the aromatic compound is selected from the group consisting an aromatic aprotic solvent and a solid aromatic compound;
the aromatic aprotic solvent is selected from the group consisting of benzene, benzene with partial or full substitutions of hydrogen with fluorine, toluene, toluene with partial or full substitutions of hydrogen with fluorine, o-xylene, o-xylene with partial or full substitutions of hydrogen with fluorine, m-xylene, m-xylene with partial or full substitutions of hydrogen with fluorine, p-xylene, p-xylene with partial or full substitutions of hydrogen with fluorine, and mesitylene, mesitylene with partial or full substitutions of hydrogen with fluorine, and combinations thereof; and
the solid aromatic compound is selected from the group consisting of hexamethylbenzene, hexamethylbenzene with partial or full substitutions of hydrogen with fluorine, biphenyl, biphenyl with partial or full substitutions of hydrogen with fluorine, naphthalene, naphthalene with partial or full substitutions of hydrogen with fluorine, and combinations thereof.

7. The electrolyte according to claim 1, wherein the aromatic compound comprises between about 1 mol % and about 80 mol % of a total solvent content.

8. The electrolyte according to claim 1, wherein the aromatic compound is selected from the group consisting of an aromatic solvent and a mixture of aromatic compounds, the at least one solvent is at least one additional solvent, and the at least one additional solvent is at least one additional aromatic solvent.

9. The electrolyte according to claim 1, wherein the aromatic compound is an aromatic solvent, the at least one solvent is at least one additional solvent, and the at least one additional solvent is an aromatic aprotic solvent and another solvent selected from the group consisting of an ether solvent, an ester solvent, a sulfone solvent, a carbonate solvent, poly(ethylene oxide), an ionic liquid, a nitrile solvent, and combinations thereof.

10. The electrolyte according to claim 1, wherein the at least one solvent is between 1 and 5 additional solvents.

11. The electrolyte according to claim 1 further comprising an additive salt selected from the group consisting of a salt of Li, Ca, Na, Zn, Mg, Cs, and combinations thereof.

12. The electrolyte according to claim 11, wherein the additive salt is selected from a bis(fluorosulfonyl)imide, a borohydride, a bis(trifluoromethanesulfonyl)imide, an alkoxyborate, an alkoxyaluminate, a boron cluster anion and combinations thereof.

13. The electrolyte according to claim 11, wherein the additive salt is between about 1 mol % and about 50 mol % of the boron cluster anion plus additive salt total content.

14. The electrolyte according to claim 1 further comprising a battery with the metal cation, the boron cluster anion, and the solvent mixture.

15. An electrolyte comprising:
a metal cation selected from the group consisting of Li⁺, Na⁺, Mg²⁺, Ca²⁺, and/or Zn²⁺;
a mixture of boron cluster anions; and
a solvent mixture comprising at least one solvent and an aromatic aprotic compound selected from the group consisting of an aromatic aprotic solvent and a solid aromatic compound, wherein:
the aromatic aprotic solvent is selected from the group consisting of benzene, benzene with partial or full substitutions of hydrogen with fluorine, toluene, toluene with partial or full substitutions of hydrogen with fluorine, o-xylene, o-xylene with partial or full substitutions of hydrogen with fluorine, m-xylene, m-xylene with partial or full substitutions of hydrogen with fluorine, p-xylene, p-xylene with partial or full substitutions of hydrogen with fluorine, and mesitylene, mesitylene with partial or full substitutions of hydrogen with fluorine, and combinations thereof; and
the solid aromatic compound is selected from the group consisting of hexamethylbenzene, hexamethylbenzene with partial or full substitutions of hydrogen with fluorine, biphenyl, biphenyl with partial or full substitutions of hydrogen with fluorine, naphthalene, naphthalene with partial or full substitutions of hydrogen with fluorine, and combinations thereof.

16. The electrolyte according to claim 15, wherein the mixture of boron cluster anions is selected form the group consisting of:
[B_{y}H_{(y-z)}R_{z}]²⁻, [CB_{(y-1)}H_{(y-2)}R_{z}]⁻, [C₂B_{(y-2)}H_{(y-t-1)}Rₜ]⁻, [C₂B_{(y-3)}H_{(y-t)}Rₜ]⁻, or [C₂B_{(y-3)}H_{(y-t-1)}Rₜ]²⁻, where y is an integer within a range of 6 to 12, z is an integer within a range of 0 to y, t is an integer within a range of 0 to (y−1), and R is a linear, branched-chain, or cyclic C1-C18 alkyl or partially or totally fluorinated alkyl group;
[B_{y}H_{(y-z-i)}R_{z}Xᵢ]²⁻, [CB_{(y-1)}H_{(y-z-i)}R_{z}Xᵢ]⁻, [C₂B_{(y-2)}H_{(y-t-j-1)}RₜXⱼ]⁻, [C₂B_{(y-3)}H_{(y-t-j)}RₜXⱼ]⁻, or [C₂B_{(y-3)}H₍ₜ₋ₜ₋ⱼ₋₁₎RₜXⱼ]²⁻, and where y is an integer within a range of 6 to 12; (z+i) is an integer within a range of 0 to y, (t+j) is an integer within a range of 0 to (y−1), X is F, Cl, Br, I, or a combination thereof, and R is a linear, branched-chain, or cyclic C1-C18 alkyl or fluoroalkyl group; and
combinations of:
[B_{y}H_{(y-z)}R_{z}]²⁻, [CB_{(y-1)}H_{(y-2)}R_{z}]⁻, [C₂B_{(y-2)}H_{(y-t-1)}Rₜ]⁻, [C₂B_{(y-3)}H_{(y-t)}Rₜ]⁻, or [C₂B_{(y-3)}H_{(y-t-1)}Rₜ]²⁻, where y is an integer within a range of 6 to 12, z is an integer within a range of 0 to y, t is an integer within a range of 0 to (y−1), and R is a linear, branched-chain, or cyclic C1-C18 alkyl or partially or totally fluorinated alkyl group; and
[B_{y}H_{(y-z-i)}R_{z}Xᵢ]²⁻, [CB_{(y-1)}H_{(y-z-i)}R_{z}Xᵢ]⁻, [C₂B_{(y-2)}H_{(y-t-j-1)}RₜXⱼ]⁻, [C₂B_{(y-3)}H_{(y-t-j)}RₜXⱼ]⁻, or [C₂B_{(y-3)}H_{(y-t-j-1)}RₜXⱼ]²⁻, and where y is an integer within a range of 6 to 12; (z+i) is an integer within a range of 0 to y, (t+j) is an integer within a range of 0 to (y−1), X is F, Cl, Br, I, or a combination thereof, and R is a linear, branched-chain, or cyclic C1-C18 alkyl or fluoroalkyl group.

17. The electrolyte according to claim 16, wherein the at least one solvent is between 1 and 5 additional solvents independently selected from the group consisting of an ether solvent, an ester solvent, a sulfone solvent, a carbonate solvent, poly(ethylene oxide), an ionic liquid, a nitrile solvent, and combinations thereof.

18. An electrochemical cell comprising:
an anode selected from the group consisting of an intercalation anode, a metal anode, and an alloy anode;
an anode current collector comprising a reactive metal selected from the group consisting of Mg, Ca, and Si;
a cathode selected from the group consisting of an insertion cathode, a conversion cathode, an organic cathode; and
an electrolyte comprising:
a metal cation selected from the group consisting of Li⁺, Na⁺, Mg²⁺, Ca²⁺, and/or Zn²⁺;
a boron cluster anion; and
a solvent mixture comprising an aromatic compound and at least one solvent.

19. The electrochemical cell according to claim 18, wherein:
the aromatic compound is selected from the group consisting an aromatic aprotic solvent and a solid aromatic compound;
the aromatic aprotic solvent is selected from the group consisting of benzene, benzene with partial or full substitutions of hydrogen with fluorine, toluene, toluene with partial or full substitutions of hydrogen with fluorine, o-xylene, o-xylene with partial or full substitutions of hydrogen with fluorine, m-xylene, m-xylene with partial or full substitutions of hydrogen with fluorine, p-xylene, p-xylene with partial or full substitutions of hydrogen with fluorine, and mesitylene, mesitylene with partial or full substitutions of hydrogen with fluorine, and combinations thereof; and
the solid aromatic compound is selected from the group consisting of hexamethylbenzene, hexamethylbenzene with partial or full substitutions of hydrogen with fluorine, biphenyl, biphenyl with partial or full substitutions of hydrogen with fluorine, naphthalene, naphthalene with partial or full substitutions of hydrogen with fluorine, and combinations thereof.

20. The electrochemical cell according to claim 19, wherein the anode current collector is a Mg anode current collector, the metal cation is Li⁺, and Li plating of the Mg anode current collector exhibits a lower overpotential for a plating capacity up to 3.5 mAh·cm⁻² compared to Li plating of a Cu anode current collector under the same conditions.
